(19) United States
(12) Patent Application Publication
(10) Pub. No.: US 2009/0018824 A1
(43) Pub. Date: Jan. 15, 2009

(54) AUDIO ENCODING DEVICE, AUDIO DECODING DEVICE, AUDIO ENCODING SYSTEM, AUDIO ENCODING METHOD, AND AUDIO DECODING METHOD

(75) Inventor: Chun Woei Teo, Singapore (SG)

Correspondence Address: GREENBLUM & BERNSTEIN, P.L.C., 1950 ROLAND CLARKE PLACE, RESTON, VA, 20191, US

(73) Assignee: MATSUSHITA ELECTRIC INDUSTRIAL CO., LTD., Osaka (JP)

(21) Appl. No.: 12/162,645

(22) PCT Filed: Jan. 30, 2007
(86) PCT No.: PCT/JP2007/051503

§ 371 Date: Jul. 30, 2008

(30) Foreign Application Priority Data
Jan. 31, 2006 (JP) 2006-023756

(51) Int. Cl. G10L 19/02; G10L 19/08; G10L 19/06

(52) U.S. Cl. 704/203; 704/205; 704/219; 704/500; 704/E19.023; 704/E19.035

(57) ABSTRACT

Provided is an audio encoding device for modeling a spectrum waveform and accurately restoring the spectrum waveform. The audio encoding device includes: an FFT unit (104) for subjecting a spectrum amplitude of a drive sound source signal to an FFT process to obtain an FFT transform coefficient; a second spectrum amplitude calculation unit (105) for calculating a second spectrum amplitude of the FFT transform coefficient; a peak point position identification unit (106) for identifying the positions of the most significant N peaks of the second spectrum amplitude; a coefficient selection unit (107) for selecting FFT transform coefficients corresponding to the identified positions; and a quantization unit (108) for quantizing the selected FFT transform coefficients.

### TECHNICAL FIELD

The present invention relates to a speech coding apparatus, speech decoding apparatus, speech coding system, speech coding method and speech decoding method.

### BACKGROUND ART

Speech codecs (monaural codecs) that encode the monaural representations of speech signals are a norm today. Such monaural codecs are commonly used for communication devices such as mobile telephones and teleconference equipment where the signals usually come from a single source (e.g. human speech).

Presently, monaural signals provide good enough quality due to the limited transmission band of communication devices and processing speed of DSPs. However, with improvement in the technology and bandwidth, these limits are becoming less significant and higher quality is in demand.

One problem with monaural speech is that it does not provide spatial information such as sound imaging or the position of the speaker. There are therefore demands for realizing good stereo quality at minimum possible rates to enable better sound realization.

One method of coding stereo speech signals involves a signal prediction or signal estimation technique. That is to say, one channel is encoded using a prior known audio coder and the other channel is predicted or estimated from the coded channel using secondary information of the other channel.

This method is disclosed, for example, in non-patent document 1 as part of the binaural cue coding system disclosed in non-patent document 1, and is applied to the calculation of interchannel level differences (ILDs) to adjust the channel level of one channel based on the reference channel.

However, predicted signals or estimated signal are oftentimes not very accurate compared to the original signal. Therefore, the predicted signals or estimated signals need to be enhanced to be maximally close to the original signals.

Audio and speech signals are commonly processed in the frequency domain. This frequency domain data is commonly referred to as “spectral coefficients” in the transformed domain. Therefore the above prediction and estimation are carried out in the frequency domain. For example, the left and/or right channel spectral data can be estimated by extracting part of its secondary information and applying it to the monaural channel (see patent document 1).

Other methods include estimating one channel from the other channel such as estimating the left channel from the right channel. This estimation is possible by estimating spectral energy or spectral amplitude in audio and speech processing. This is referred to as spectral energy prediction or scaling.

In typical spectral energy prediction, time domain signals are converted to frequency domain signals. A frequency domain signal is usually divided into frequency bands according to the critical band. This division is done for both the reference channel and the channel that is subject to estimation. For each frequency band of both channels, the energy is calculated and a scale factor is calculated using the energy ratio between both channels. The scale factors are transmitted to the receiver side where the reference channel is scaled using this scale factors to retrieve an estimated signal in the transformed domain for each frequency band. Following this, an inverse frequency transform is performed to obtain a time domain signal corresponding to the estimated transformed domain spectral data.

According to the method disclosed in non-patent document 1 above, the frequency domain spectral coefficients are divided into critical band, and the energy and scale factor of each band are calculated directly. This basic idea of the prior art method is to adjust the energy of each band such that each evenly divided band has virtually the same energy as the energy the original signal.
Patent Document 1: International Publication No. 03/090208 pamphlet
Non-Patent Document 1: C. Faller and F. Baumgarte, “Binaural cue coding: A novel and efficient representation of spatial audio”, Proc. ICASSP, Orlando, Fla., October 2002.

### DISCLOSURE OF INVENTION

### Problem to be Solved by the Invention

Although the above-described method disclosed in non-patent document 1 can be implemented at ease and makes the power of each band close to the original signals, the method is not able to provide model more detailed spectral waveforms, because spectral waveforms usually contain details that do not resemble the original signals.

It is therefore an object of the present invention to provide a speech coding apparatus, speech decoding apparatus, speech coding system, speech coding method and speech decoding method for modeling spectral waveforms and recover spectral waveforms.

The speech coding apparatus of the present invention employs a configuration having: a transform section that performs a frequency domain transform of a first input signal and constructs a frequency domain signal; a first calculation section that calculates a first spectral amplitude of the frequency domain signal; a second calculation section that performs a frequency domain transform of the first spectral amplitude and calculates a second spectral amplitude; a specifying section that specifies positions of a highest plurality of peaks in the second spectral amplitude; a selection section that selects transformed coefficients of the second spectral amplitude corresponding to the specified positions of peaks; and a quantization section that quantizes the selected transformed coefficients.

The speech decoding apparatus of the present invention employs a configuration having: an inverse quantization section that acquires a highest plurality of quantized transformed coefficients from coefficients obtained by performing a frequency domain transform of an input signal twice, and performs an inverse quantization of the acquired transformed coefficients; a spectral coefficient construction section that arranges the transformed coefficients in the frequency domain and constructs spectral coefficients; and an inverse transform section that reconstructs a spectral amplitude estimate by performing an inverse frequency transform of the spectral coefficients, and acquires a linear value of the spectral amplitude estimate.

The speech coding system of the present invention employs a configuration having a speech coding apparatus and a speech decoding apparatus, where: the speech coding apparatus has: a transform section that performs a frequency domain transform of a first input signal and constructs a frequency domain signal; a first calculation section that calculates a first spectral amplitude of the frequency domain signal; a second calculation section that performs a frequency domain transform of the first spectral amplitude and calculates a second spectral amplitude; a specifying section that specifies positions of a highest plurality of peaks in the second spectral amplitude; a selection section that selects transformed coefficients of the second spectral amplitude corresponding to the specified positions of peaks; and a quantization section that quantizes the selected transformed coefficients; and the speech decoding apparatus has: an inverse quantization section that acquires a highest plurality of quantized transformed coefficients from coefficients obtained by performing a frequency domain transform of an input signal twice, and performs an inverse quantization of the acquired transformed coefficients; a spectral coefficient construction section that arranges the transformed coefficients in the frequency domain and constructs spectral coefficients; and an inverse transform section that reconstructs a spectral amplitude estimate by performing an inverse frequency transform of the spectral coefficients, and acquires a linear value of the spectral amplitude estimate.

### Advantageous Effect of the Invention

The present invention makes it possible to model spectral waveforms and recover spectral waveforms and accurately.

### BRIEF DESCRIPTION OF DRAWINGS

FIG. 1 is a block diagram showing a configuration of a speech signal spectral amplitude estimating apparatus according to embodiment 1 of the present invention;

FIG. 2 is a block diagram showing a configuration of a speech signal spectral amplitude estimate decoding apparatus according to embodiment 1 of the present invention;

FIG. 3 shows the spectra of stationary signals;

FIG. 4 shows the spectra of non-stationary signals;

FIG. 5 is a block diagram showing a configuration of a speech coding system according to embodiment 1 of the present invention;

FIG. 6 is a block diagram showing a configuration of a residue signal estimating apparatus according to embodiment 2 of the present invention;

FIG. 7 is a block diagram showing a configuration of an estimated residue signal estimate decoding apparatus according to embodiment 2 of the present invention;

FIG. 8 shows how coefficients are assigned to subframe divisions; and

FIG. 9 is a block diagram showing a configuration of a stereo speech coding system according to embodiment 2 of the present invention.

### BEST MODE FOR CARRYING OUT THE INVENTION

Embodiments of the present invention will be explained below in detail with reference to the accompanying drawings. In the following embodiments, the same components will be assigned the same reference numerals and their explanations will not repeat.

### Embodiment 1

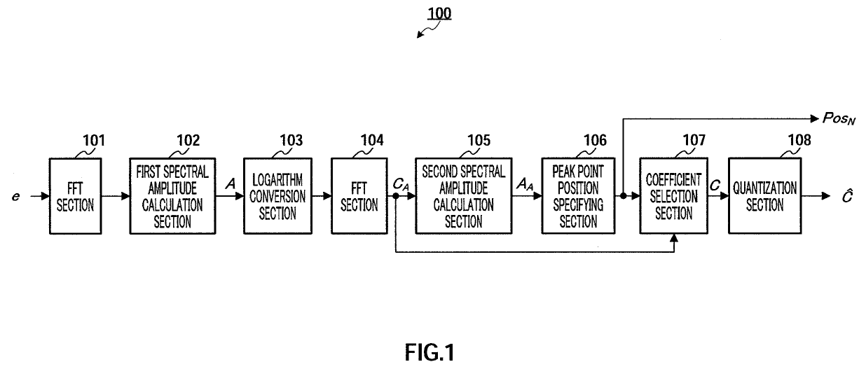

FIG. 1 is a block diagram showing a configuration of speech signal spectral amplitude estimating apparatus 10 according to embodiment 1 of the present invention. This spectral amplitude estimating apparatus 100 is used primarily in speech coding apparatus. In this drawing, FFT (Fast Fourier Transform) section 101, upon receiving an excitation signal e as input, transforms this excitation signal e into a frequency domain signal by the forward frequency transform and outputs the result to first spectral amplitude calculation section 102. This input signal can be either the monaural, left or right channel of the signal source.

First spectral amplitude calculation section 102 calculates the amplitude A of the frequency domain excitation signal e outputted from FFT section 101, and outputs the calculated spectral amplitude A to logarithm conversion section 103.

Logarithm conversion section 103 converts the spectral amplitude A outputted from first spectral amplitude calculation section 102 into a logarithm scale and outputs this to FFT section 104. The conversion into a logarithmic scale is optional, and, in case a logarithmic scale is not used, the absolute value of the spectral amplitude may be used in subsequent processes.

FFT section 104 obtains a frequency domain representation of the spectral amplitude (i.e. complex coefficients C_{A}) by performing a second forward frequency transform on the logarithmic scale spectral amplitude outputted from logarithm conversion section 103, and outputs the complex coefficients C_{A} to second spectral amplitude calculation section 105 and coefficient selection section 107.

Second spectral amplitude calculation section 105 calculates the spectral amplitude A_{A} of the spectral amplitude A using the complex coefficient C_{A}, and outputs the calculated spectral amplitude A_{A} to peak point position specifying section 106. FFT section 104 and second spectral amplitude calculation section 105 may be operated as one calculating means.

Peak point position specifying section 106 searches for the first to N-th highest peaks in the spectral amplitude A_{A} inputted from second spectral amplitude calculation section 105 and searches for the positions of the first to N-th highest peaks POS_{N}. The searched positions of the first to N-th peaks POS_{N} are outputted to coefficient selection section 107.

Based on the peak positions POS_{N} outputted from peak point position specifying section 106, coefficient selection section 107 selects N of the complex coefficients C_{A} outputted from FFT section 104, and output the selected N complex coefficients C to quantization section 108.

Quantization section 108 quantizes the complex coefficient C outputted from coefficient selection section 107 using a scalar or vector quantization method and outputs the quantized coefficients Ĉ.

The quantized coefficients Ĉ and the peak positions POS_{N} are transmitted to the spectral amplitude estimate decoding apparatus of the decoder side and are reconstructed on the decoder side.

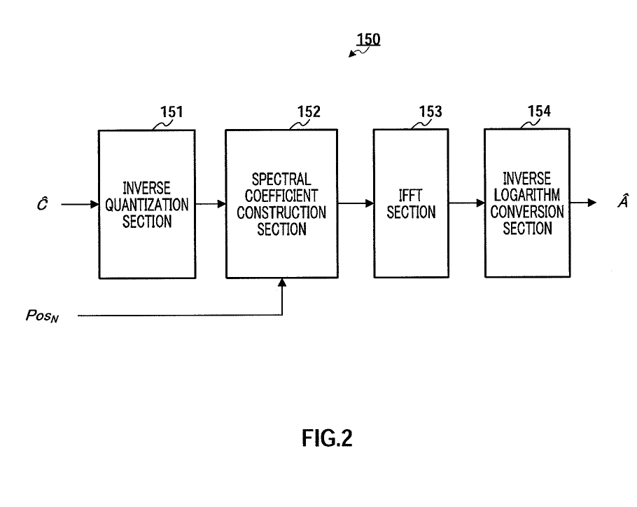

FIG. 2 is a block diagram showing the configuration of spectral amplitude estimate decoding apparatus 150 according to embodiment 1 of the present invention. This spectral amplitude estimate decoding apparatus is used primarily in speech decoding apparatus. In this drawing, inverse quantization section 151 inverse-quantizes the quantized coefficients Ĉ transmitted from spectral amplitude estimating apparatus shown in FIG. 1 and obtains coefficients, and outputs the acquired coefficients to spectral coefficient construction section 152.

Spectral coefficient construction section 152 individually maps the coefficients outputted from inverse quantization section 151 to the peak positions POS_{N} transmitted from spectral amplitude estimating apparatus 100 shown in FIG. 1 and maps coefficients of zeroes to the rest of the positions. By this means, the spectral coefficients (complex coefficients) that are required in the inverse frequency transform are constructed. The number of samples with these coefficients is the same as the number of samples in the coefficients at the encoder side. For example, if the length of the spectral amplitude A_{A} is 64 samples and N is 20, then the coefficients mapped in 20 locations specified by POS_{N} for both real and imaginary numbers while the other 44 locations are mapped coefficients of zeroes. The spectral coefficients constructed by this means are outputted to IFFT (Inverse Fast Fourier Transform) section 153.

IFFT section 153 reconstructs the estimate of the spectral amplitude in a logarithmic scale by performing an inverse frequency transform of the spectral coefficients outputted from spectral coefficient construction section 152. The spectral amplitude estimate reconstructed in a logarithmic scale is outputted to inverse logarithm conversion section 154.

Inverse logarithm conversion section 154 calculates the inverse logarithm of the spectral amplitude estimate outputted from IFFT section 153 and obtains a spectral amplitude Â in a linear scale. As mentioned earlier, the conversion into a logarithmic scale is optional, and, therefore, if spectral amplitude estimating apparatus 100 doe not have logarithm conversion section 103, then there will not be inverse logarithm conversion 154 either. In this case, the result of the inverse frequency transform in IFFT section 153 would be a linear scale reconstruction of the spectral amplitude estimate.

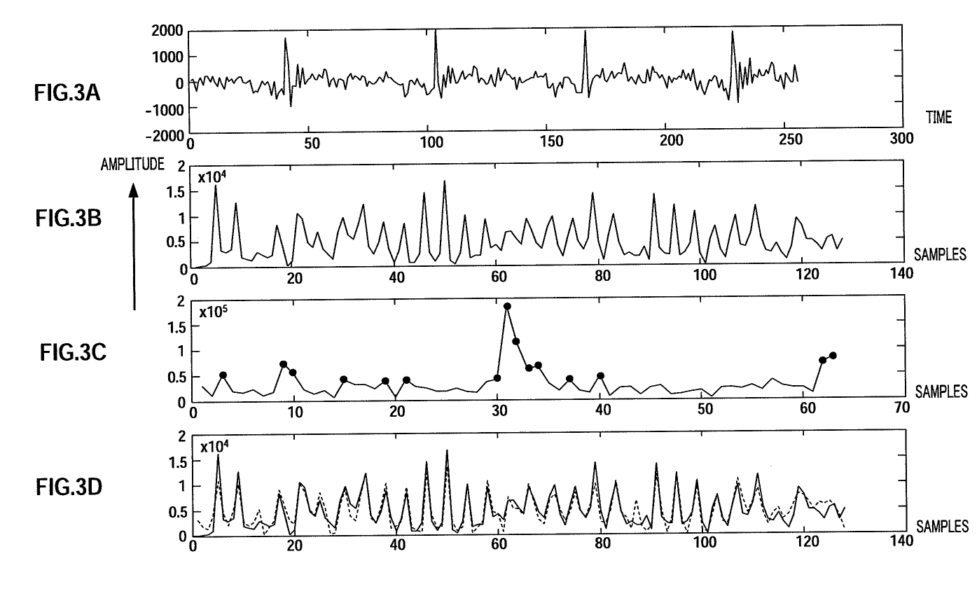

FIG. 3 shows the spectra of stationary signals. FIG. 3A shows a time domain representation of one frame of a stationary portion of an excitation signal. FIG. 3B shows the spectral amplitude of the excitation signal after the signal is converted from the time domain into the frequency domain. With a stationary signal, the spectral amplitude exhibits a regular periodicity as shown in the graph of FIG. 3B.

If the spectral amplitude is treated just like any signal and is frequency-transformed, the above periodicity is expressed as a signal with peaks in the graph of FIG. 3C, when the transformed spectral amplitude is calculated. Taking advantage of this feature, the spectral amplitude can be estimated from the graph of FIG. 3(b) by finding fewer (real and imaginary) coefficients. For example, by encoding the peak at point 31 in the graph of FIG. 3B, the periodicity of the spectral amplitude is practically determined.

FIG. 3C shows a set of coefficients corresponding to the locations marked by the black-dotted peak points. By performing an inverse transform using few coefficients, an estimate of the spectral amplitude such as shown with the dotted line in FIG. 3D, can be obtained.

To further improve the efficiency, the positions of main peaks such as point 31 and their neighboring points can be derived from the periodicity or the pitch period of the signal and therefore need not be sent.

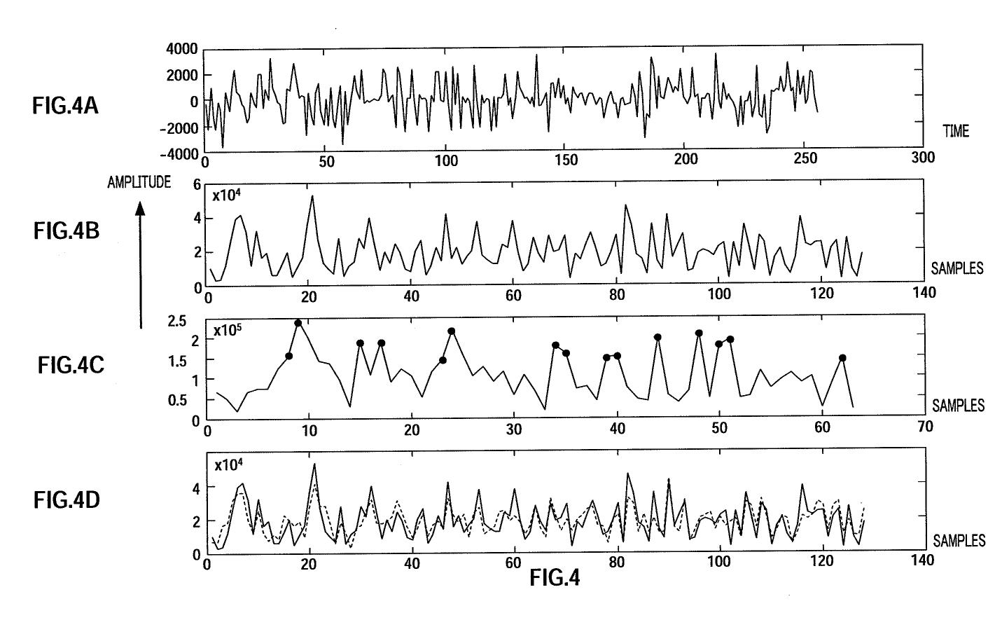

FIG. 4 shows the spectra of non-stationary signals. FIG. 4A shows a time domain representation of one frame of a stationary portion of an excitation signal. Similar to stationary signals, the spectral amplitude of a stationary signal can be estimated.

FIG. 4B shows the spectral amplitude of the excitation signal after the signal is converted from the time domain into the frequency domain. With a non-stationary signal, the spectral amplitude exhibits no periodicity, as shown in FIG. 4B. In the non-stationary portion of a signal, there is no concentration of signals in any particular part as shown in FIG. 4C, and, instead, points are distributed.

In the graph of FIG. 3C, there is a peak at point 31, and, by encoding this point, the periodicity of the spectral amplitude is determined, so that, by encoding the other points, the details of the spectral amplitude improve. By this means, the spectral amplitude of the signal can be estimated using fewer coefficients than the length of the signal of the target of processing.

By contrast with this, by carefully choosing the correct points, such as shown with the black-dotted peak points shown in FIG. 4C, an estimate of the spectral amplitude can still be obtained as shown with the dotted line in the bottom plot of FIG. 4.

By this means, with signals having stable structures like stationary signals, information is usually transmitted by a certain FFT transformed coefficient. This coefficient has a larger value than other coefficients, and signals can be represented by selecting such coefficients. Consequently, the spectral amplitude of a signal can be represented using fewer coefficients. That is to say, by representing coefficients with fewer bits, it is possible to reduce the bit rate. Incidentally, a spectral amplitude can be recovered more accurately as the number of the coefficients used in representing the spectral amplitude increases.

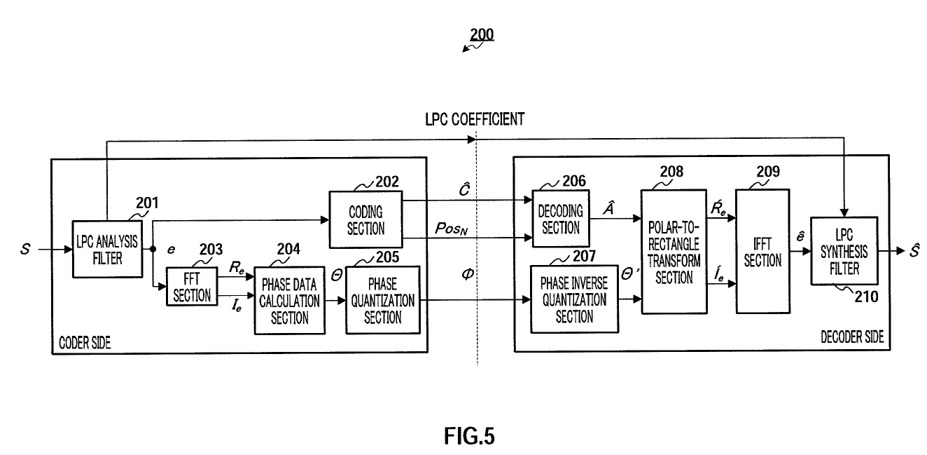

FIG. 5 is a block diagram showing the configuration of speech coding system 200 according to embodiment 1 of the present invention. The coder side will be described first.

LPC analysis filter 201 filters an input speech signal S and produces LPC coefficients and an excitation signal e. The LPC coefficients are transmitted to LPC synthesis filter 210 of the decoder side, and the excitation signal e is outputted to coding section 202 and FFT section 203.

Coding section 202, having the configuration of the spectral amplitude estimating apparatus shown in FIG. 1, estimates the spectral amplitude of the excitation signal e outputted from LPC analysis section 201, acquires the coefficients Ĉ and the peak positions Pos_{N}, and outputs the quantized coefficients Ĉ and peak positions Pos_{N} to decoding section 206 of the decoder side.

FFT section 203 transforms the excitation signal e outputted from LPC analysis filter 201 into the frequency domain, generates a complex spectral coefficient (Rₑ, Iₑ), and outputs the complex spectral coefficient to phase data calculation section 204.

Phase data calculation section 204 calculates the phase data Θ of the excitation signal e using the complex spectral coefficient outputted from FFT section 203, and outputs the calculated phase data Θ to phase quantization section 205.

Phase quantization section 205 quantizes the phase data Θ outputted from phase data calculation section 204 and transmits the quantized phase data Φ to phase inverse quantization section 207 of the decoder side.

The decoder side will be described next.

Decoding section 206, having the configuration of the spectral amplitude estimate decoding apparatus shown in FIG. 2, finds a spectral amplitude estimate Â of the excitation signal e using the quantized coefficients Ĉ and peak positions Pos_{N} transmitted from coding section 202 of the coder side, and outputs the acquired spectral amplitude estimate Â to polar-to-rectangle transform section 208.

Phase inverse quantization section 207 inverse-quantizes the quantized phase data Φ transmitted from phase quantization section 205 of the coder side and acquires phase data Θ′ , and outputs this data to polar-to-rectangle transform section 208.

Polar-to-rectangle transform section 208 transforms the phase spectral amplitude estimate Â outputted from decoding section 206 into a complex spectral coefficient (R′ₑ,I′ₑ) with real and imaginary numbers, and outputs this complex coefficient to IFFT section 209.

IFFT section 209 transforms the complex spectral coefficient outputted from polar-to-rectangle transform section 208 from a frequency domain signal to a time domain signal, and acquires an estimated excitation signal ê. The estimated excitation signal ê is outputted to LPC synthesis filter 210.

LPC synthesis filter 210 synthesizes an estimated input signal S′ using the estimated excitation signal ê outputted from IFFT section 209 and the LPC coefficients outputted from LPC analysis filter 201 of the coder side.

By this means, according to Embodiment 1, the coder side determines FFT transformed coefficients by performing FFT processing on the spectral amplitude of an excitation signal, specifies the positions of the highest N peaks amongst the peaks in the spectral amplitude corresponding to the FFT coefficients, and selects the spectral coefficients corresponding to the specified positions, so that the decoder side is able to recover the spectral amplitude by constructing spectral coefficients by mapping the FFT transformed coefficients selected on the coder side to the positions also specified on the coder side and performing IFFT processing on the spectral coefficients constructed. Consequently, the spectral amplitude can be represented with fewer FFT transformed coefficients. FFT transformed coefficients can be represented with a smaller number of bits, so that the bit rate can be reduced.

### Embodiment 2

Although a case of estimating the spectral amplitude has been described above with embodiment 1, a case of encoding the difference between the reference signal and an estimate of the reference signal (i.e. residue signal) will be described with embodiment 2 of the present invention. A residue signal is more like a random signal with a tendency to be non-stationary and is similar to the spectra shown in FIG. 4. Therefore it is still possible to apply the method explained in embodiment 1 to estimate the residue signal.

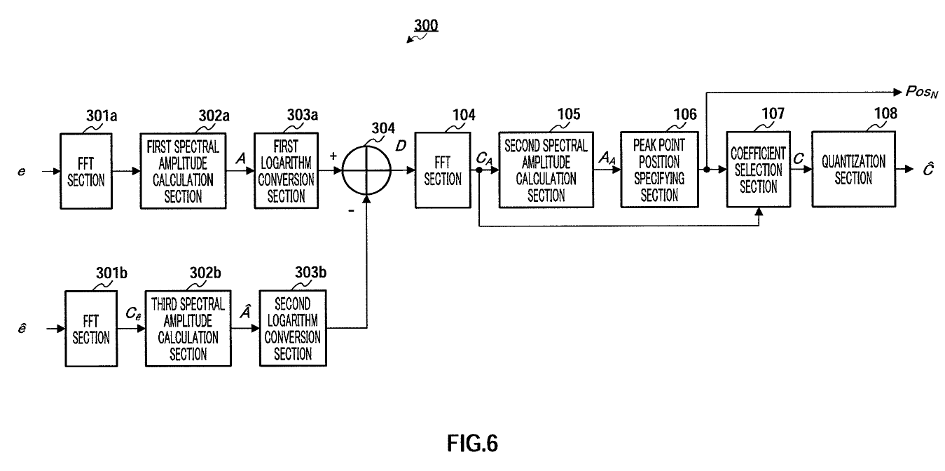

FIG. 6 is a block diagram showing the configuration of residue signal estimating apparatus 300 according to embodiment 2 of the present invention. This residue signal estimating apparatus 300 is used primarily in speech coding apparatus. In this drawing, FFT section 301a transforms a reference excitation signal e to a frequency domain signal by the forward frequency transform, and outputs this frequency domain signal to first spectral amplitude calculation section 302a.

First spectral amplitude calculation section 302a calculates the spectral amplitude A of the reference excitation signal outputted from FFT section 301a in the frequency domain, and outputs the spectral amplitude A to first logarithm conversion section 303a.

First logarithm conversion section 303a converts the spectral amplitude A outputted from first spectral amplitude calculation section 302a into a logarithmic scale and outputs this to addition section 304.

FFT section 301b performs the same processing as in FFT section 301a upon an estimated excitation signal ê. The same applies to third spectral amplitude calculation section 302b and first spectral amplitude calculation section 302a, and second logarithm conversion section 303b and first logarithm scale conversion section 303a.

Using the spectral amplitude outputted from first logarithm conversion section 303a as the reference value, addition section 304 calculates the difference spectral amplitude D (i.e. residue signal) with respect to the estimated spectral amplitude value outputted from second logarithm conversion section 303b, and outputs this difference spectral amplitude D to FFT section 104.

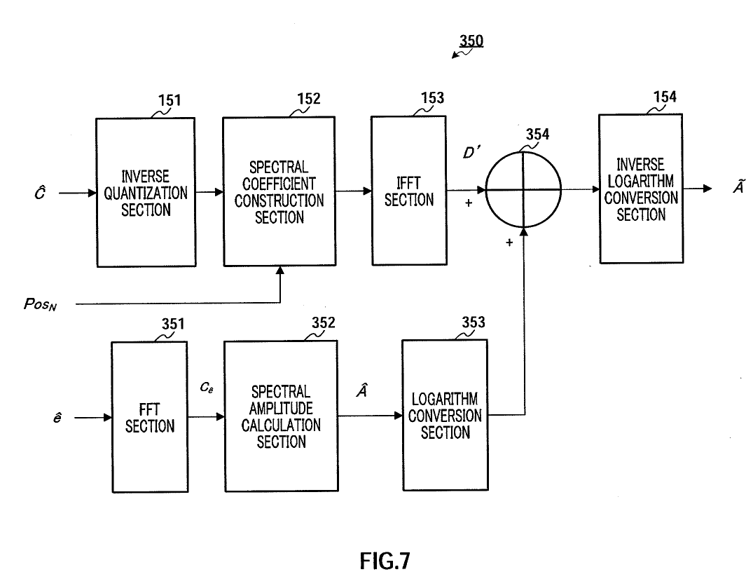

FIG. 7 is a block diagram showing the configuration of estimated residual signal estimate decoding apparatus 350 according to embodiment 2 of the present invention. This estimated residue signal estimate decoding apparatus 350 is primarily used in speech decoding apparatus. In this drawing, IFFT section 153 reconstructs a difference spectral amplitude estimate D′ in a logarithmic scale by performing an inverse frequency transform on spectral coefficients outputted from spectral coefficient construction section 152. The reconstructed difference spectral amplitude estimate D′ is outputted to addition section 354.

FFT section 351 constructs transformed coefficients Cₑ̂ by performing a forward frequency transform of the estimated excitation signal ê and outputs the transformed coefficients to spectral amplitude calculation section 352.

Spectral amplitude calculation section 352 calculates the spectral amplitude A of the estimated excitation signal, that is, calculate an estimated spectral amplitude Â, and outputs this estimated spectral amplitude Â to logarithm conversion section 353.

Logarithm conversion section 353 converts the estimated spectral amplitude Â outputted from spectral amplitude calculation section 352 into a logarithmic scale and outputs this to addition section 354.

Addition section 354 adds the difference spectral amplitude estimate D′ outputted from IFFT section 153 and the estimate of the spectral amplitude in a logarithmic scale outputted from logarithmic conversion section 353, and acquires an enhanced spectral amplitude estimate. Addition section 354 outputs the enhanced spectral amplitude estimate to inverse logarithmic conversion section 154.

Inverse logarithmic conversion section 154 calculates the inverse logarithm of the estimate with an emphasized spectral amplitude outputted from addition section 354 and converts the spectral amplitude into a vector amplitude A˜ in a logarithmic scale.

If, in FIG. 6, the difference spectral amplitude D is in a logarithmic scale, then, in FIG. 7, the spectral amplitude estimate Â outputted from spectral amplitude calculation section 352 needs to be converted into a logarithmic scale in logarithm conversion section 353, before it is added to the difference spectral amplitude estimate D′ found in IFFT section 153, so as to obtain an enhanced spectral amplitude estimate in a logarithmic scale. However, if in FIG. 6 the difference spectral amplitude D is not given in a logarithmic scale, logarithm conversion section 353 and inverse logarithm conversion section 154 are not used. Therefore, the difference spectral amplitude D′ reconstructed in IFFT section 153 is added directly to the spectral amplitude estimate A′ outputted from spectral amplitude calculation section 352 and acquires an enhanced spectral amplitude estimate A˜.

According to the present embodiment, the difference spectral amplitude signal D covers the whole of a frame. However, instead of deriving the difference spectral amplitude signal D from the entire frame, it is equally possible to divide the frame of the difference spectral amplitude D into M subframes and derive a spectral amplitude signal D from each subframe. As for the size of the subframes, they may be divided either evenly or nonlinearly.

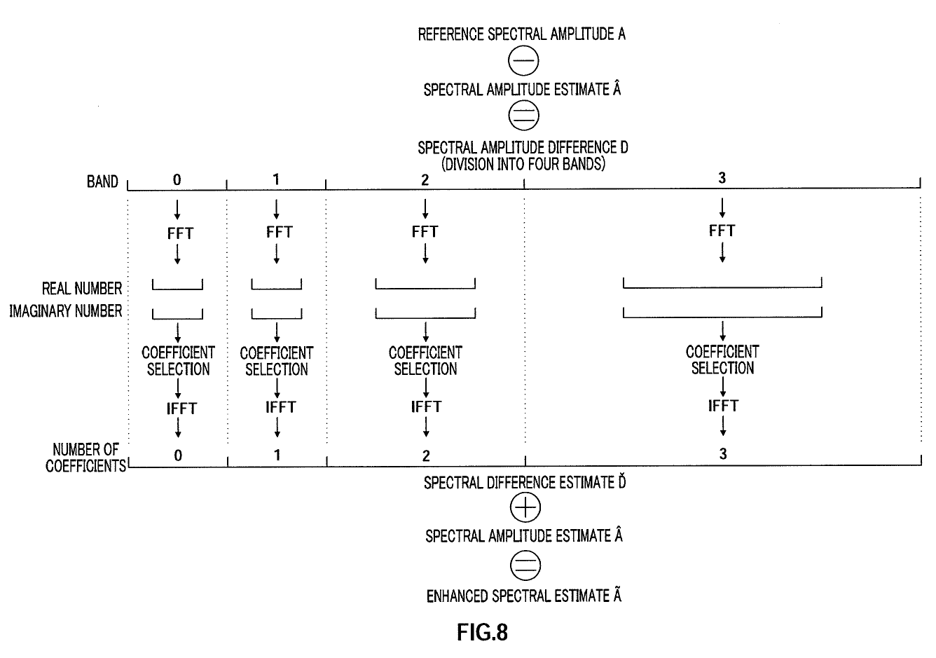

FIG. 8 illustrates a case where one frame is divided non-linearly into four subframes, where the lower band has the smaller subframes and the higher band has the bigger subframes. The difference spectral amplitude signal D is applied to these subframes.

One advantage of using subframes is that different number of coefficients can be assigned between individual subframes depending on importance. For example, the lower subframes, which correspond to the lower frequency band, are considered important, so that a greater number of coefficients may be assigned to this band than the higher subframes of the higher band. FIG. 8 illustrates a case where the higher subframes are assigned the greater number of coefficients than the lower subframes.

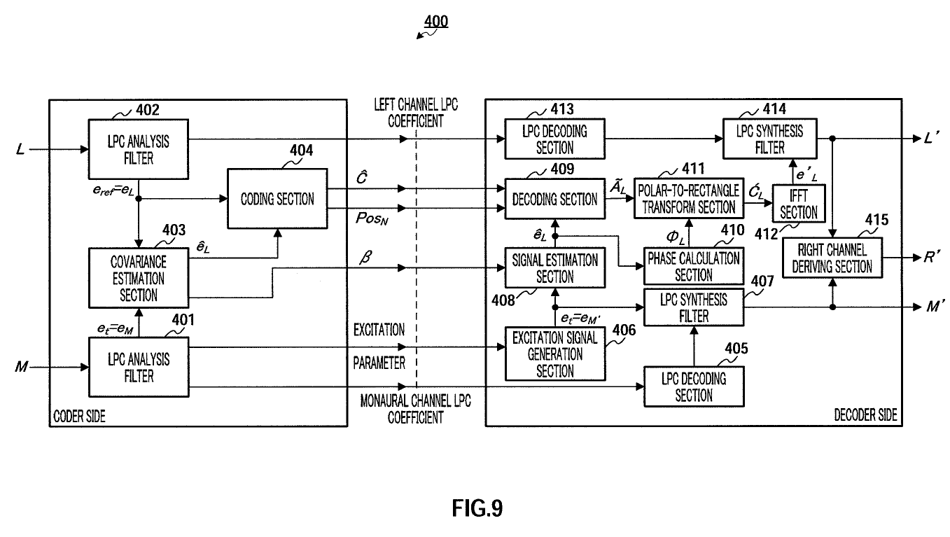

FIG. 9 is a block diagram showing the configuration of stereo speech coding system 400 according to embodiment 2 of the present invention. The basic idea with this system is to encode the reference monaural channel, predict or estimate the left channel from the monaural channel, and derives the right channel from the monaural and left channels. The coder side will be described first.

Referring to FIG. 9, LPC analysis filter 401 filters a monaural channel signal M, finds an monaural excitation signal e_{M}, monaural channel LPC coefficient and excitation parameter, and outputs the monaural excitation signal e_{M} to covariance estimation section 403, the monaural channel LPC coefficient to LPC decoding section 405 of the decoder side, and the excitation parameter to excitation signal generation section 406 of the decoder side. The monaural excitation signal e_{M} serves as the target signal for the prediction of the left channel excitation signal.

LPC analysis filter 402 filters the left channel signal L, finds an left channel excitation signal e_{L} and a left channel LPC coefficient, and outputs the left channel excitation signal e_{L} to the covariance estimation section 403 and coding section 404, and the left channel LPC coefficient to LPC decoding section 413 of the decoder side. The left channel excitation signal e_{L} serves as the reference signal in the prediction of the left channel excitation signal.

Using the monaural excitation signal e_{M} outputted from LPC analysis filter 401 and the left channel excitation signal e_{L} outputted from LPC analysis filter 402, covariance estimation section 403 estimates the left channel excitation signal by minimizing following equation 1, and outputs the estimated left channel excitation signal ê_{L} to coding section 404.

$${\sum }_{n = 0}^{L} {[ {e}_{L} ( n ) - {\sum }_{i = 0}^{P} {β}_{i} {e}_{M} ( n - i ) ]}^{2} \qquad ( Equation 1 )$$

where P is the filter length, L is the length of signal to process, and β are the filter coefficients. The filter coefficients β are also transmitted to signal estimation section 408 of the decoder side to estimate the left channel excitation signal.

Coding section 404, having the configuration of residue signal estimating apparatus shown in FIG. 6, finds the transformed coefficients Ĉ and peak positions POS_{N} using the reference excitation signal e_{L} outputted from LPC analysis filter 402 and the estimated excitation signal ê_{L} outputted from covariance estimation section 403, and transmits the transformed coefficients Ĉ and peak positions POS_{N} to decoding section 409 of the decoder side.

The decoder side will be described next.

LPC decoding section 405 decodes the monaural channel LPC coefficients transmitted from the LPC analysis filter 401 of the coder side and outputs the monaural channel LPC coefficients to LPC synthesis filter 407.

Excitation signal generation section 406 generates a monaural excitation signal e_{M}, using the excitation signal parameter transmitted from LPC analysis filter 401 of the decoder side, and outputs this monaural excitation signal e_{M′} to LPC synthesis filter 407 and signal estimation section 408.

LPC synthesis filter 407 synthesizes output monaural speech M′ using the monaural channel LPC coefficient outputted from LPC decoding section 405 and the monaural excitation signal e_{M′} outputted from excitation signal generation section 406, and outputs this output monaural speech M′ to right channel deriving section 415.

Signal estimation section 408 estimates the right channel excitation signal by filtering the monaural excitation signal e_{M′} outputted from excitation signal generation section 406 by the filter coefficients β transmitted from covariance estimation section 403 of the coder side, and outputs the estimated right channel excitation signal ê_{L} to decoding section 409 and phase calculation section 410.

Decoding section 409, having the configuration of the estimated residual signal estimate decoding apparatus shown in FIG. 7, acquires the enhanced spectral amplitude A˜_{L} of the left channel excitation signal using the estimated left channel excitation signal ê_{L} transmitted from signal estimation section 408, and the transformed coefficients Ĉ and peak positions POS_{N} outputted from coding section 404 of the coder side, and outputs this enhanced spectral amplitude A˜_{L} to polar-to-rectangle transform section 411.

Phase calculation section 410 calculates phase data Φ_{L} from the estimated left channel excitation signal ê_{L} outputted from signal estimation section 408, and outputs the calculated phase data Φ_{L} to polar-to-rectangle transform section 411. This phase data Φ_{L}, together with the amplitude Â_{L}, forms the polar form of the enhanced spectral excitation signal.

Polar-to-rectangle transform section 411 converts the enhanced spectral amplitude A˜_{L} outputted from decoding section 409 using the phase data Φ_{L} outputted from phase calculation section 410 from a polar form into a rectangle form, and outputs this to IFFT section 412.

IFFT section 412 converts the enhanced spectral amplitude in a rectangle form outputted from polar-to-rectangle transform section 411 from a frequency domain signal to a time domain signal by the inverse frequency transform, and constructs an enhanced spectral excitation signal e′_{L}. The enhanced spectral excitation e′_{L} is outputted to LPC synthesis filter 414.

LPC decoding section 413 decodes the left channel LPC coefficient transmitted from LPC analysis filter 402 of the coder side and outputs the decoded left channel LPC coefficient to LPC synthesis filter 414.

LPC synthesis filter 414 synthesizes the left channel signal L′ using the enhanced spectral excitation signal e′_{L} outputted from IFFT section 412 and the left channel LPC coefficient outputted from LPC decoding section 413, and outputs the result to right channel deriving section 415.

Assuming that the monaural signal M can be derived on the coder side from M=½(L+R), the right channel signal R′ can be derived from the relationship between the output monaural speech M′ outputted from LPC synthesis filter 407 and the let channel signal L′ outputted from LPC synthesis filter 414. That is to say, the right channel signal R′ can be derived from the relational equation R′=2M′−L′.

According to Embodiment 2, on the decoder side, the residue signal between the spectral amplitude of the reference excitation signal ad the spectral amplitude of an estimated excitation signal is encoded, and, on the decoder side, by recovering the residue signal and adding the recovered residue signal to a spectral amplitude estimate, the spectral amplitude estimate is enhanced and made closer to the spectral amplitude of the reference excitation signal before coding.

Embodiments have been described above.

Although a case has been described with the above embodiments as an example where the present invention is implemented with hardware, the present invention can be implemented with software.

Furthermore, each function block employed in the description of each of the aforementioned embodiments may typically be implemented as an LSI constituted by an integrated circuit. These may be individual chips or partially or totally contained on a single chip. “LSI” is adopted here but this may also be referred to as “IC,” “system LSI,” “super LSI,” or “ultra LSI” depending on differing extents of integration.

Further, the method of circuit integration is not limited to LSI's, and implementation using dedicated circuitry or general purpose processors is also possible. After LSI manufacture, utilization of an FPGA (Field Programmable Gate Array) or a reconfigurable processor where connections and settings of circuit cells in an LSI can be reconfigured is also possible.

Further, if integrated circuit technology comes out to replace LSI's as a result of the advancement of semiconductor technology or a derivative other technology, it is naturally also possible to carry out function block integration using this technology. Application of biotechnology is also possible.

The disclosure of Japanese Patent Application No. 2006-023756, filed on Jan. 31, 2006, including the specification, drawings and abstract, is incorporated herein by reference in its entirety.

### INDUSTRIAL APPLICABILITY

The speech coding apparatus, speech decoding apparatus, speech coding system, speech coding method and speech decoding method according to the present invention model spectral waveforms and recover spectral waveforms accurately, and are applicable to communication devices such as mobile telephones and teleconference equipment.

1. A speech coding apparatus comprising:
a transform section that performs a frequency domain transform of a first input signal and constructs a frequency domain signal;
a first calculation section that calculates a first spectral amplitude of the frequency domain signal;
a second calculation section that performs a frequency domain transform of the first spectral amplitude and calculates a second spectral amplitude;
a specifying section that specifies positions of a highest plurality of peaks in the second spectral amplitude;
a selection section that selects transformed coefficients of the second spectral amplitude corresponding to the specified positions of peaks; and
a quantization section that quantizes the selected transformed coefficients.

2. The speech coding apparatus according to claim 1, where the first spectral amplitude is a logarithmic value.

3. The speech coding apparatus according to claim 1, wherein the first spectral amplitude is an absolute value.

4. The speech coding apparatus according to claim 1, wherein the quantization section performs the quantization in one of scalar quantization and vector quantization.

5. A speech decoding apparatus comprising:
an inverse quantization section that acquires a highest plurality of quantized transformed coefficients from coefficients obtained by performing a frequency domain transform of an input signal twice, and performs an inverse quantization of the acquired transformed coefficients;
a spectral coefficient construction section that arranges the transformed coefficients in the frequency domain and constructs spectral coefficients; and
an inverse transform section that reconstructs a spectral amplitude estimate by performing an inverse frequency transform of the spectral coefficients, and acquires a linear value of the spectral amplitude estimate.

6. The speech decoding apparatus according to claim 5, wherein the spectral coefficient construction section maps the transformed coefficients in positions of a highest plurality of transformed coefficients selected from the transformed coefficients obtained by performing the frequency domain transform of the input signal twice and maps zeroes in the rest of positions.

7. A speech coding system comprising:
a speech coding apparatus comprising:
a transform section that performs a frequency domain transform of a first input signal and constructs a frequency domain signal;
a first calculation section that calculates a first spectral amplitude of the frequency domain signal;
a second calculation section that performs a frequency domain transform of the first spectral amplitude and calculates a second spectral amplitude;
a specifying section that specifies positions of a highest plurality of peaks in the second spectral amplitude;
a selection section that selects transformed coefficients of the second spectral amplitude corresponding to the specified positions of peaks; and
a quantization section that quantizes the selected transformed coefficients; and
a speech decoding apparatus comprising:
an inverse quantization section that acquires a highest plurality of quantized transformed coefficients from coefficients obtained by performing a frequency domain transform of an input signal twice, and performs an inverse quantization of the acquired transformed coefficients;
a spectral coefficient construction section that arranges the transformed coefficients in the frequency domain and constructs spectral coefficients; and
an inverse transform section that reconstructs a spectral amplitude estimate by performing an inverse frequency transform of the spectral coefficients, and acquires a linear value of the spectral amplitude estimate.

8. A speech coding method comprising:
a transform step of performing a frequency domain transform of a first input signal and constructing a frequency domain signal;
a first calculation step of calculating a first spectral amplitude of the frequency domain signal;
a second calculation step of performing a frequency domain transform of the first spectral amplitude and calculating a second spectral amplitude;
a specifying step of specifying positions of a highest plurality of peaks in the second spectral amplitude;
a selection step of selecting transformed coefficients of the second spectral amplitude corresponding to the specified positions of peaks; and
a quantization step of quantizing the selected transformed coefficients.

9. A speech decoding method comprising:
an inverse quantization step of acquiring a highest plurality of quantized transformed coefficients from coefficients obtained by performing a frequency domain transform of an input signal twice, and performing an inverse quantization of the acquired transformed coefficients;
a spectral coefficient construction step of arranging the transformed coefficients in the frequency domain and constructing spectral coefficients; and
an inverse transform step of reconstructing a spectral amplitude estimate by performing an inverse frequency transform of the spectral coefficients, and acquiring a linear value of the spectral amplitude estimate.
